(19) United States
(12) Patent Application Publication
(10) Pub. No.: US 2008/0055222 A1
(43) Pub. Date: Mar. 6, 2008

(54) Charge pump pixel driving circuit

(75) Inventors: Heng-Yin Chen, Hsinchu City (TW); Jih-Fon Huang, Hsinchu City (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/601,663

(22) Filed: Nov. 20, 2006

(30) Foreign Application Priority Data
Sep. 5, 2006 (TW) 95132681

(51) Int. Cl. G09G 3/36

(52) U.S. Cl. 345/90

(57) ABSTRACT

The present invention provides a charge pump pixel driving circuit, which includes a first storage capacitor, a second storage capacitor and switch means. The first end of the second storage capacitor is coupled to a pixel electrode. The switch means responsive to a control signal to couple a signal voltage to the first ends of the first storage capacitor and second capacitor until the first ends of the first storage capacitor and second capacitor are charged to a voltage equal to the signal voltage. Then, the signal voltage is decoupled from the first storage capacitor and second storage capacitor, and the first end of the first storage capacitor is coupled to the second end of the second storage capacitor so that the first end of the second storage capacitor provides a voltage twice the signal voltage to the pixel electrode.

### BACKGROUND OF THE INVENTION

1. Field of the Invention

The present invention relates to a pixel driving circuit, and more particularly to a charge pump pixel driving circuit.

2. Description of Related Art

Charge pump is a circuit design for voltage multiplication, which can be employed in the pixel driving circuit of a display panel to design a charge pump pixel such that the data driving voltage can be boosted to twice or more times so as to eliminate power consumption or furthermore simplify the data driving circuit design.

U.S. Pat. No. 5,903,248 provides a charge pump pixel driving circuit 100 applicable in the pixel driving circuit of the display device, as shown in FIG. 1. The charge pump pixel driving circuit 100 is used for driving a pixel 106 of an active matrix liquid crystal display device. The pixel 106 is constituted by a back plate electrode 110, a front plate electrode 111 and liquid crystal material 112 sandwiched between the two electrodes. The back-plate electrode 110 is coupled to the pixel driving circuit 100, and the front-plate electrode 111 is coupled to a common reference voltage Vcom. The pixel display voltage Vpixel across the pixel 106 is equal to the voltage difference between the back plate electrode 110 and the front plate voltage 111. The pixel driving circuit 100 includes a storage capacitor 104 and transistors 102, 107 and 108. A drain of the transistor 102 is coupled to a signal voltage bus 103, and a source of the transistor 102 is coupled to a high voltage-level end of the storage capacitor 104 and the back plate electrode 110, as well as a gate of the transistor 102 is coupled to a first control signal bus 101. The signal voltage VA is sent out through the signal voltage bus 103, and a first control signal VSC1 is sent out through the first control signal bus 101. A drain of the transistor 107 is coupled to the signal voltage bus 103, and a source of the transistor 107 is coupled to a low voltage-level end of the storage capacitor 104, as well as a gate of the transistor 107 is coupled to a second control signal bus 105. A second control signal VSC2 is sent out through the second control bus 105. A source of the transistor 108 is coupled to the low voltage-level end of the storage capacitor 104 and the source of the transistor 107, and the drain of the transistor 108 is grounded, as well as a gate of the transistor 108 is coupled to the first control signal bus 101 through a connection line 109.

FIG. 2A through FIG. 2F are operating waveform diagrams of the charge pump pixel driving circuit 100 for driving the pixel 106 to a clear state, in which FIG. 2A is an operating waveform diagram of the common reference voltage (Vcom) applied to the pixel 106. FIG. 2B is an operating waveform diagram of the signal voltage VA coupled to the drains of the transistors 102 and 107. FIG. 2C is an operating waveform diagram of the first control signal VSC1 applied to the gates of the transistors 102 and 108, and FIG. 2D is an operating waveform diagram of the second control signal VSC2 applied to the gate of the transistor 107. From t0˜t1, the first control signal VSC1 is a high voltage-level signal to switch on the transistors 102 and 108, while the second control signal VSC2 is a low voltage-level signal to switch off the transistor 107 such that the voltage across the storage capacitor 104 is charged to the signal voltage VA, and making the voltage VB of the high voltage-level end of the storage capacitor 104 being equal to the signal voltage VA. From t1˜t3, the first control signal VSC1 is a low voltage-level signal to switch off the transistors 102 and 108, while the second control signal VSC2 is a high voltage-level signal to switch on the transistor 107, and making the signal voltage VA decoupled from the high voltage-level end of the storage capacitor 104 but coupled to the low voltage-level end of the storage capacitor 104. As such, the voltage VB of the high voltage-level end of the storage capacitor 104 is boosted to 2VA, and thus providing the voltage twice the signal voltage to the back plate electrode 110 of the pixel 106.

The charge pump pixel driving circuit 100 of FIG. 1 only provides a boosting voltage twice the signal voltage. And, because the transistor 107 uses the signal voltage VA as the data input source, the transistor 107 needs to keep constantly switch-on for a frame time. In the event that the signal voltage VA is varied during the frame time, the pixel voltage of the pixel 106 would be varied as well. If the transistor 107 is switched off during the frame time, the voltage (VA) for holding charge pump will disappear, and the VB point returns to the voltage level before charge pump. The above two changes influence the performance of color display. And thus, the charge pump pixel driving circuit 100 of U.S. Pat. No. 5,903,248 is only applicable in a monochromatic display panel and can not meet the demand of the current display device. Moreover, the charge pump pixel driving circuit 100 also needs an additional control line, and making scan lines and scan driving circuit need to be doubled.

Accordingly, it is desirable for providing an improved charge pump pixel driving circuit to overcome the drawbacks of the conventional techniques.

### SUMMARY OF THE INVENTION

The present invention is to provide a charge pump pixel driving circuit, which can provide approximately twice or more times a data signal voltage to a pixel electrode.

The present invention is to provide a charge pump pixel driving circuit, which employs a storage capacitor for firstly storing a signal voltage so as to keep a constant output voltage provided to the pixel electrode, and hence the voltage of the pixel electrode is not influenced by fluctuation of the signal voltage transmitted on a data line, and thus the charge pump pixel driving circuit of the present invention is applicable in a colorful display panel.

The present invention is to provide a charge pump pixel driving circuit, which only needs a control signal line and thus can simplify the design of the pixel driving circuit.

The present invention provides a charge pump pixel driving circuit for providing a voltage to a pixel electrode, which comprises a first storage capacitor, a second storage capacitor and a switch means. The first storage capacitor has a first end and a second end in which the second end is grounded. The second storage capacitor has a first end and a second end in which the first end is coupled to the pixel electrode. The switch means is responsive to a first control signal to couple a signal voltage to the first ends of the first storage capacitor and the second storage capacitor until the first ends of the first storage capacitor and the second storage capacitor are charged to a voltage equal to the signal voltage, and then decoupling the signal voltage from the first ends of the first storage capacitor and the second storage capacitor and making the first end of the first storage capacitor couple to the second end of the second storage capacitor such that the first end of the second storage capacitor provides approximately twice the signal voltage to the pixel electrode.

In one another aspect, the present invention provides another type of charge pump pixel driving circuit for providing a voltage to a pixel electrode, which comprises a first storage capacitor, a second storage capacitor, a third storage capacitor and a switch means. The first storage capacitor has a first end and a second end in which the second end is grounded. The second storage capacitor has a first end and a second end in which the first end is coupled to the first end of the first storage capacitor. The third storage capacitor has a first end and a second end in which the first end is coupled to the first end of the second storage capacitor and the pixel electrode. The switch means is responsive to a first control signal to couple a signal voltage to the first ends of the first storage capacitor, the second storage capacitor and the third storage capacitor until the first ends of the first storage capacitor, the second storage capacitor and the third storage capacitor are charged to a voltage equal to the signal voltage, and making the signal voltage decoupled from the first ends of the first storage capacitor, the second storage capacitor and the third storage capacitor, and making the first end of the first storage capacitor coupled to the second end of the second storage capacitor and the first end of the second storage capacitor coupled to the second end of the third storage capacitor such that the first end of the third storage capacitor provides approximately three times the signal voltage to said pixel electrode.

The above two types of charge pump pixel driving circuit can boost approximately twice or more times the data signal voltage provided to the pixel electrode. Moreover, the first storage capacitors of the above two types of charge pump pixel driving circuit can firstly store the signal voltage to keep the constant output voltage of the pixel driving circuit provided to the pixel electrode, and thus the voltage of the pixel electrode is not influenced by the fluctuation of the signal voltage during a unit frame time. The color performance of the display is maintained.

### BRIEF DESCRIPTION OF THE DRAWINGS

FIG. 1 is a schematic view of a conventional charge pump pixel driving circuit;

FIG. 2A through FIG. 2F is operating waveform diagrams of the conventional charge pump pixel driving circuit of FIG. 1;

FIG. 3 is a schematic view of a charge pump pixel driving circuit according to a first preferred embodiment of the present invention;

FIG. 4A and FIG. 4B are operating waveform diagrams of the charge pump pixel driving circuit of FIG. 3;

FIG. 5A is a voltage diagram of an output voltage of the charge pump pixel driving circuit of FIG. 3 during a unit scan time;

FIG. 5B is a voltage diagram of the output voltage of the charge pump pixel driving circuit of FIG. 3 during a unit frame time;

FIG. 6 is a schematic view of a charge pump pixel driving circuit according to a second preferred embodiment of the present invention;

FIG. 7A and FIG. 7B are operating waveform diagrams of the charge pump pixel driving circuit of FIG. 6;

FIG. 8A is a voltage diagram of an output voltage of the charge pump pixel driving circuit of FIG. 6 during a unit scan time;

FIG. 8B is a voltage diagram of the output voltage of the charge pump pixel driving circuit of FIG. 6 during a unit frame time;

FIG. 9 is a schematic view of a charge pump pixel driving circuit according to a third preferred embodiment of the present invention;

FIG. 10 is an operating waveform diagram of the charge pump pixel driving circuit of FIG. 9;

FIG. 11A is a voltage diagram of an output voltage of the charge pump pixel driving circuit of FIG. 9 during a unit scan time;

FIG. 11B is a voltage diagram of the output voltage of the charge pump pixel riving circuit of FIG. 9 during a unit frame time;

FIG. 12 is a schematic view of a charge pump pixel driving circuit according to a fourth preferred embodiment of the present invention;

FIG. 13 is an operating waveform diagram of the charge pump pixel driving circuit of FIG. 12;

FIG. 14A is a voltage diagram of an output voltage of the charge pump pixel driving circuit of FIG. 12 during a unit scan time;

FIG. 14B is a voltage diagram of the output voltage of the charge pump pixel driving circuit of FIG. 12 during a unit scan time after boosting the data signal voltage; and

FIG. 14C is a voltage diagram of the output voltage of the charge pump pixel driving circuit of FIG. 12 during a unit frame time after boosting the data signal voltage.

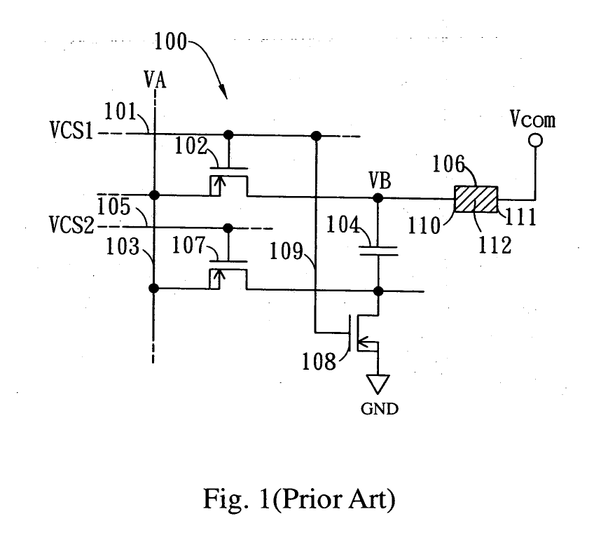

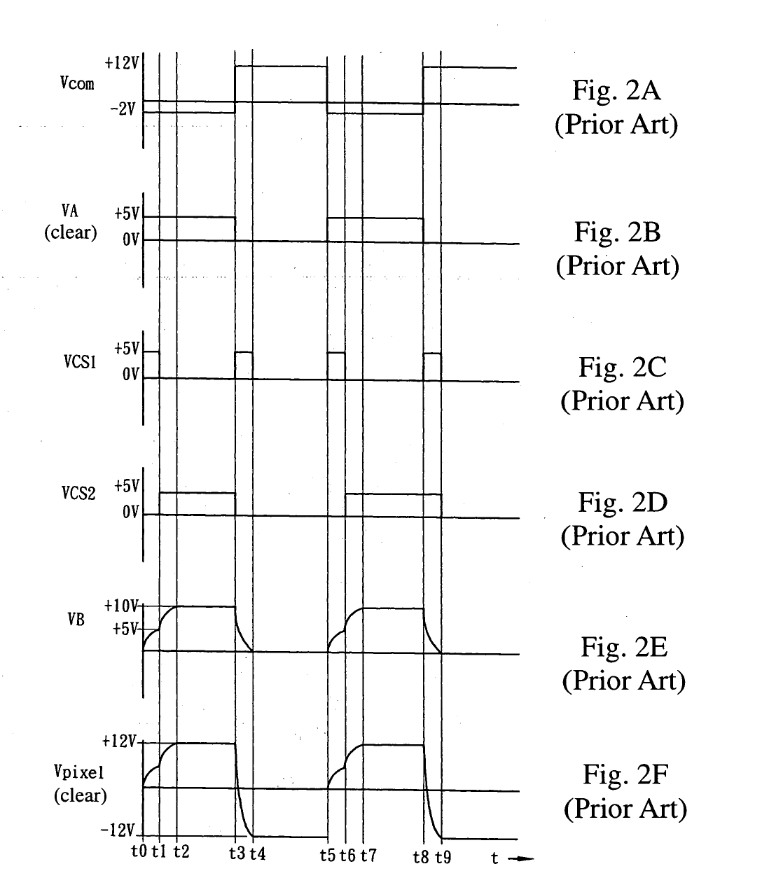

### DETAILED DESCRIPTION OF THE-PREFERRED EMBODIMENTS

The charge pump pixel driving circuit of the present invention will be described in detail according to preferred embodiments accompanying with drawings.

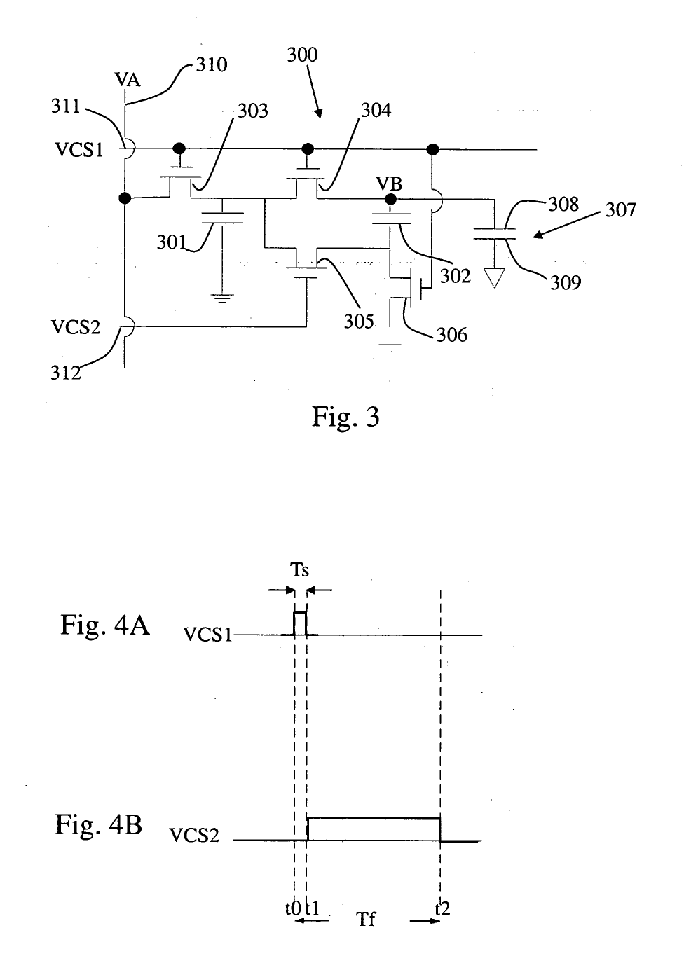

FIG. 3 is a schematic view of the charge pump pixel driving circuit in accordance with a first preferred embodiment of the present invention. In the first preferred embodiment, the charge pump pixel driving circuit 300 includes a first storage capacitor 301, a second storage capacitor 302 and a switch means having a first transistor 303, a second transistor 304, a third transistor 305 and a fourth transistor 306. The first transistor 303, the second transistor 304, the third transistor 305 and the fourth transistor 306 are N-channel transistors. A first end (high voltage end) of the first storage capacitor 301 is coupled to a source of the first transistor 303, and a second end (low voltage end) of the first storage capacitor 301 is grounded. A first end of the second storage capacitor 302 is coupled to a source of the second transistor 304 and a first pixel electrode 308 of a pixel 307. A second pixel electrode 309 of the pixel 307 is coupled to a common reference voltage (Vcom). A second end of the second storage capacitor 302 is coupled to a source of the third transistor 305 and a source of the fourth transistor 306. A drain of the first transistor 303 is coupled to a data signal line 310 and a source of the first transistor 303 is coupled to the first end of the first storage capacitor 301, the drains of the second transistor 304 and the third transistor 305, and a gate of the first transistor 303 is coupled to a first control signal line 311. A drain of the second transistor 304 is coupled to the source of the first transistor 303, the first end of the first storage capacitor 301 and a drain of the third transistor 305. A source of the second transistor 304 is coupled to the first end of the second storage capacitor 302, and a gate of the second transistor 304 is coupled to the first control signal line 311. A drain of the third transistor 305 is coupled to the source of the first transistor 303 and the first end of the first storage capacitor 301, and the source of the third transistor 305 is coupled to the second end of the second storage capacitor 302 and a source of the fourth transistor 306, and a gate of the third transistor 305 is coupled to a second control signal line 312. The source of the fourth transistor 306 is coupled to the second end of the second storage capacitor 302 and the source of the third transistor 305, and a drain of the fourth transistor 306 is grounded, and a gate of the fourth transistor 306 is coupled to the first control signal line 311.

FIG. 4A and FIG. 4B are operating waveform diagrams of the charge pump pixel driving circuit 300 during a frame time Tf, in which FIG. 4A is the operating waveform diagram of a first control signal VSC1 sent from the first control signal line 311, and FIG. 4B is the operating waveform diagram of a second control signal VSC2 sent from the second control signal line 312. A duration of t0˜t2 is a frame time Tf. From t0˜t1, the first control signal VSC1 is a high voltage-level signal so as to switch on the first transistor 303, the second transistor 304 and the fourth transistor 306, and then the signal voltage VA of the data signal line 310 is coupled to the first ends of the first storage capacitor 301 and the second storage capacitor 302. As a result, the first ends of the first storage capacitor 301 and the second storage capacitor 302 are charged to a voltage equal to the signal voltage VA. At this time, the second control signal VSC2 is a low voltage-level signal to switch off the third transistor 305. From t1˜t2, the first control signal VSC1 is a low voltage-level signal so as to switch off the first transistor 303, the second transistor 304 and the fourth transistor 306. As a result, the signal voltage VA is decoupled from the first storage capacitor 301 and the second storage capacitor 302. At this time, the second control signal VSC2 is a high voltage-level signal to switch on the third transistor 305 such that the first end of the first storage capacitor 301 is coupled to the second end of the second storage capacitor 302, and hence the voltage VB at the first end of the second storage capacitor 302 is boosted to 2VA, and thus providing the voltage approximately twice the signal voltage VA to the first pixel electrode 307.

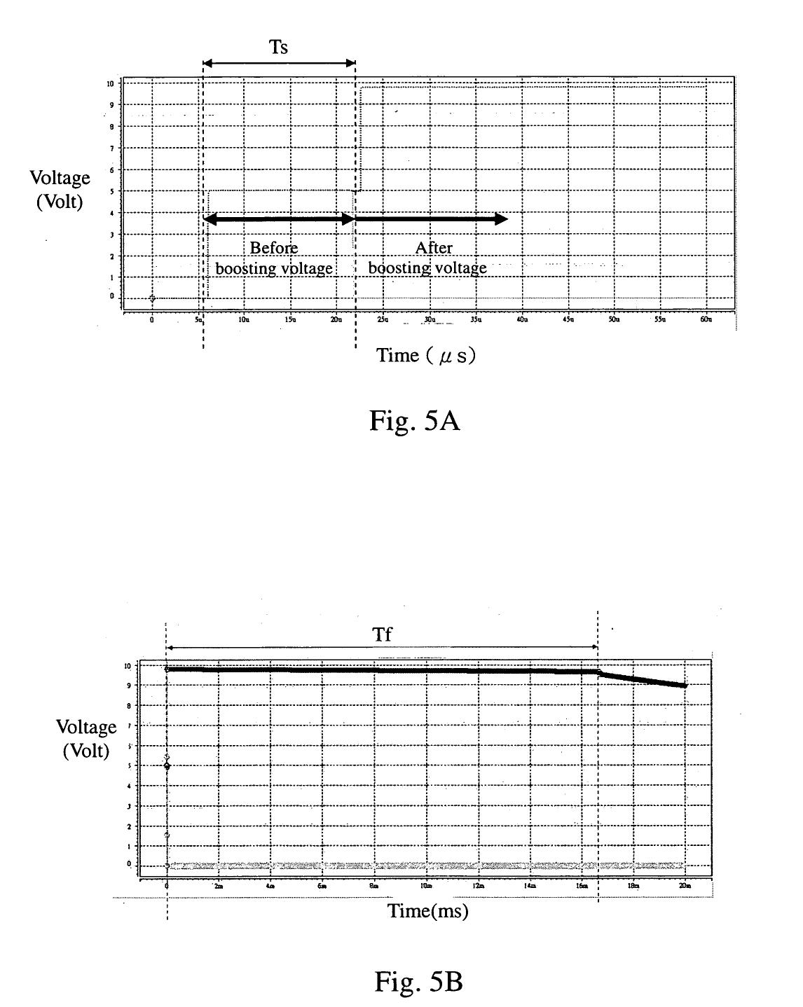

FIG. 5A is a voltage diagram of the output voltage VB of the charge pump pixel driving circuit 300 during a unit scan time Ts of the first control signal line 311. From this diagram, it is found that the voltage VA (about 5 volts) stored in the first storage capacitor 301 through switching on the third transistor 305 can make the output voltage VB boost to twice the signal voltage 2VA (about 10 volts). FIG. 5B is a voltage diagram of the output voltage VB during a frame time Tf (about 16.7 ms). From this diagram, it is found that the output voltage VB is barely decayed after passing through the frame time Tf. As such, the present charge pump pixel driving circuit 300 also has charge holding capability, that is, the signal voltage VA is firstly stored in the first storage capacitor 301 such that the output voltage VB is not influenced by the fluctuation of the signal voltage transmitted on the data signal line 310. And the performance of color display is maintained.

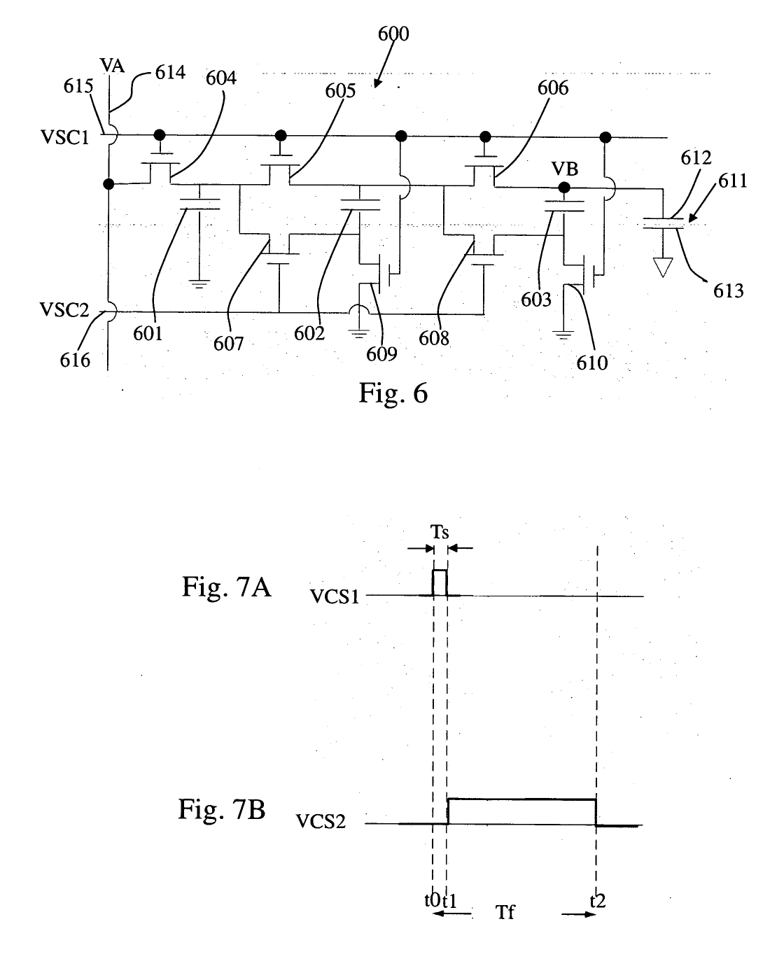

FIG. 6 is a schematic view of the charge pump pixel driving circuit in accordance with a second preferred embodiment of the present invention. In the second preferred embodiment, the charge pump pixel driving circuit 600 includes a first storage capacitor 601, a second storage capacitor 602, a third storage capacitor 603 and a switch means having a first transistor 604, a second transistor 605, a third transistor 606, a fourth transistor 607, a fifth transistor 608, a sixth transistor 609 and a seventh transistor 610, in which the first transistor 604, the second transistor 605, the third transistor 606, the fourth transistor 607, the fifth transistor 608, the sixth transistor 609 and the seventh transistor 610 are N-channel transistors. A first end of the first storage capacitor 601 is coupled to a source of the first transistor 604, a drain of the second transistor 605 and a drain of the fourth transistor 607, as well as a second end of the first storage capacitor 601 is grounded. A first end of the second storage capacitor 602 is coupled to a source of the second transistor 605, a drain of the third transistor 606 and a drain of the fifth transistor 608. A second end of the second storage capacitor 602 is coupled to a source of the fourth transistor 607 and a source of the sixth transistor 609. A first end of the third storage capacitor 603 is coupled to the source of the third transistor 606 and a first pixel electrode 612 of a pixel 611, and a second pixel electrode 613 is coupled to a common reference voltage (Vcom). A second end of the third storage capacitor 603 is coupled to a source of the fifth transistor 608 and a source of the seventh transistor. The drain of the first transistor 604 is coupled to a data signal line 614, and the source of the first transistor 604 is coupled to the first end of the first storage capacitor 601 and the drain of the second transistor 605, and a gate of the first transistor 604 is coupled to a first control signal line 615. The drain of the second transistor 605 is coupled to the first end of the first storage capacitor 601 and the drain of the fourth transistor 607, and the source of the second transistor 605 is coupled to the first end of the second storage capacitor 602, the drain of the third transistor 606 and the drain of the fifth transistor 608, and a gate of the second transistor 605 is coupled to the first control signal line 615. The drain of the third transistor 606 is coupled to the source of the second transistor 605, the first end of the second storage capacitor 602 and the drain of the fifth transistor 608. The source of the third transistor 606 is coupled to the first end of the third storage capacitor 603, and a gate of the third transistor 606 is coupled to the first control signal line 615. The drain of the fourth transistor 607 is coupled to the first end of the first storage capacitor 601 and the source of the first transistor 604, and the source of the fourth transistor 607 is coupled to the second end of the second storage capacitor 602 and the source of the sixth transistor 609. A gate of the fourth transistor 607 is coupled to a second control signal line 616. The drain of the fifth transistor 608 is coupled to the source of the second transistor 605 and the first end of the second storage capacitor 602 and the drain of the third transistor 606, and the source of the fifth transistor 608 is coupled to the second end of the third storage capacitor 603 and the source of the seventh transistor 610, and a gate of the fifth transistor 608 is coupled to the second control signal line 616. The source of the sixth transistor 609 is coupled to the second end of the second storage capacitor 602 and the source of the fourth transistor 607, and the drain of the sixth transistor is grounded, as well as a gate of the sixth transistor 609 is coupled to the first control signal 615. The source of the seventh transistor 610 is coupled to the second end of the third storage capacitor 603 and the source of the fifth transistor 608, and the drain of the seventh transistor 610 is grounded, and a gate of the seventh transistor 610 is coupled to the first control signal line 615.

FIG. 7A and FIG. 7B are operating waveform diagrams of the charge pump pixel driving circuit 600, in which FIG. 7A is the operating waveform diagram of a first control signal VSC1 sent from the first control signal line 615, and FIG. 7B is the operating waveform diagram of a second control signal VSC2 sent from the second control signal line 616. A duration of t0˜t2 is a frame time Tf. From t0˜t1, the first control signal VSC1 sent from the first control signal line 615 is a high voltage-level signal so as to switch on the first transistor 604, the second transistor 605, the third transistor 606, the sixth transistor 609 and the seventh transistor 610. As a result, the signal voltage VA of the data signal line 614 is coupled to the first ends of the first storage capacitor 601, the second storage capacitor 602 and the third storage capacitor 603 such that the first ends of the first storage capacitor 601, the second storage capacitor 602 and the third storage capacitor 603 are charged to a voltage equal to the signal voltage VA. At this time, the second control signal VSC2 is a low voltage-level signal to switch off the fourth transistor 607 and the fifth transistor 608. From t1˜t2, the first control signal VSC1 is a low voltage-level signal to switch off the first transistor 604, the second transistor 605, the third transistor 606, the sixth transistor 609 and the seventh transistor 610. As a result, the signal voltage VA is decoupled from the first storage capacitor 601, the second storage capacitor 602 and the third storage capacitor 603. At this time, the second control signal VSC2 is a high voltage-level signal to switch on the fourth transistor 607 and the fifth transistor 608 such that the first end of the first storage capacitor 601 is coupled to the second end of the second storage capacitor 602, and hence the voltage of the first end of the second storage capacitor 602 is boosted to twice the signal voltage 2VA and the first end of the second storage capacitor 602 is coupled to the second end of the third storage capacitor 603 such that the voltage VB of the first end of the third storage capacitor 603 is boosted to three times the signal voltage (3VA). As such, the first end of the third storage capacitor 603 provides the voltage (3VA) three times the signal voltage to the first pixel electrode 612 of the pixel 611.

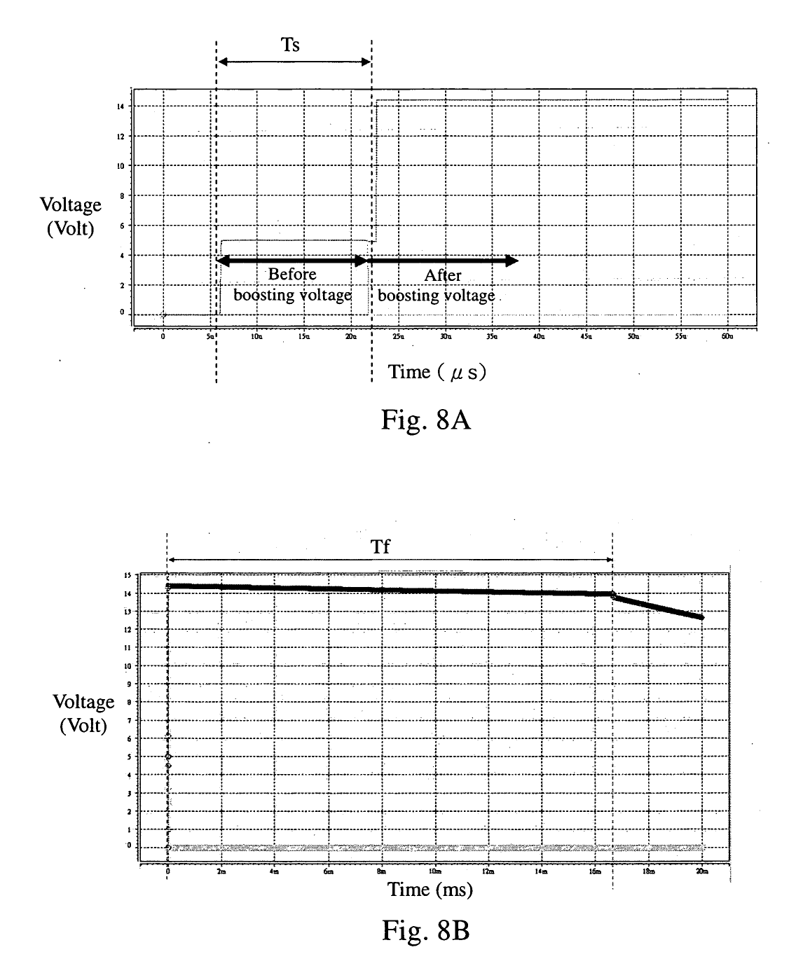

FIG. 8A is a voltage diagram of the output voltage VB of the charge pump pixel driving circuit 600 during a unit scan time Ts of the first control signal line 615. From this diagram, it is found that the voltage VA (about 5 volts) stored in the first storage capacitor 601 and the second storage capacitor 602 through switching on the fourth transistor 607 and the fifth transistor 608 can make the output voltage VB boost to three times the signal voltage (3VA about 15 volts). FIG. 8B is a voltage diagram of the output voltage VB during a frame time (Tf about 16.7 ms). From this diagram, it is found that the output voltage VB is barely decayed after passing through a frame time Tf. As such, the charge pump pixel driving circuit 600 also has charge holding capability, that is, the signal voltage VA is firstly stored in the first storage capacitor 601 such that the output voltage VB is not influenced by the fluctuation of the signal voltage transmitted on the data signal line 613. The performance of color display is thus maintained.

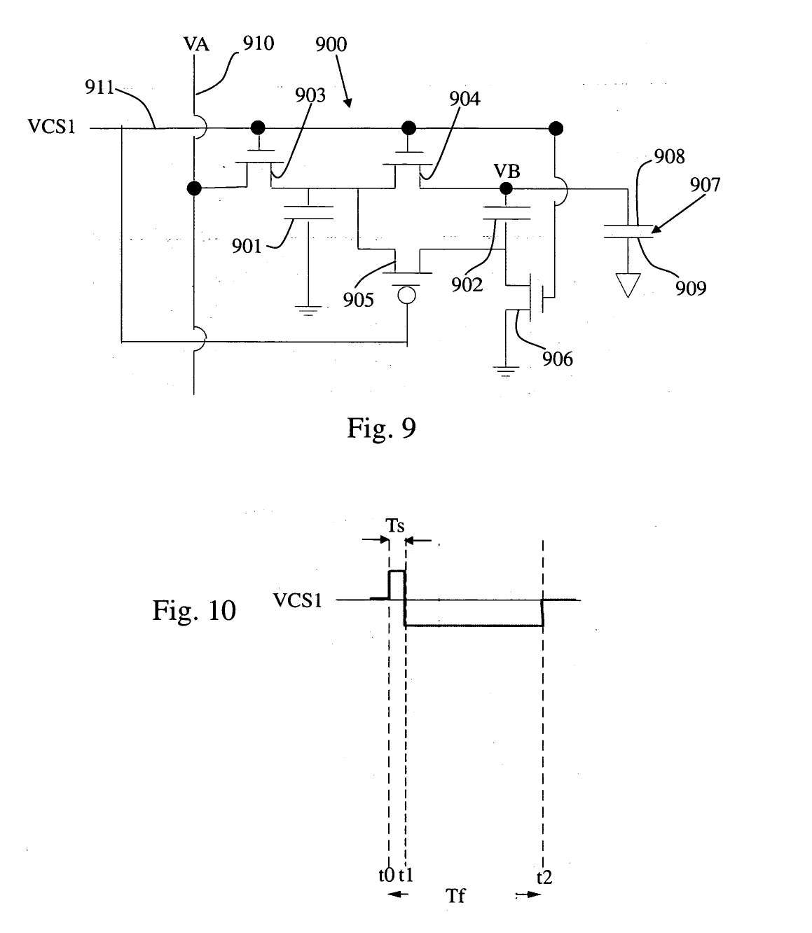

FIG. 9 is a schematic view of the charge pump pixel driving circuit in accordance with a third preferred embodiment of the present invention. In the third preferred embodiment, the charge pump pixel driving circuit 900 of the present invention includes a first storage capacitor 901, a second storage capacitor 902 and a switch means having a first transistor 903, a second transistor 904, a third transistor 905 and a fourth transistor 906 in which the first transistor 903, the second transistor 904 and the fourth transistor 906 are N-channel transistors, while the third transistor 905 is a P-channel transistor. A first end of the first storage capacitor 901 is coupled to a source of the first transistor 903, a drain of the second transistor 904 and a drain of the third transistor 905, while a second end of the first storage capacitor 901 is grounded. A first end of the second storage capacitor 902 is coupled to a source of the second transistor 904 and a first pixel electrode 908 of a pixel 907, while a second pixel electrode 909 of the pixel 907 is coupled to a common reference voltage (Vcom). A second end of the second storage capacitor 902 is coupled to a source of the third transistor 905 and a source of the fourth transistor 906. The drain of the first transistor 903 is coupled to a data signal line 910, and the source of the first transistor 903 is coupled to the first end of the first storage capacitor 901, a drain of the second transistor 904 and a drain of the third transistor 905, as well as a gate of the first transistor 903 is coupled to a control signal line 911. A drain of the second transistor 904 is coupled to the first end of the first storage capacitor 901 and a drain of the third transistor 905, and the source of the second transistor 904 is coupled to the first end of the second storage capacitor 902, and a gate of the second transistor 904 is coupled to the control signal line 911. The drain of the third transistor 905 is coupled to the first end of the first storage capacitor 901, the source of the first transistor 903 and the drain of the second transistor 904, and a source of the third transistor 905 is coupled to the second end of the second storage capacitor 902 and the source of the fourth transistor 906, as well as a gate of the third transistor 905 is coupled to the control signal line 911. The source of the fourth transistor 906 is coupled to the second end of the second storage capacitor 902, the source of the third transistor 905, and the drain of the fourth transistor 906 is grounded, as well as a gate of the fourth transistor 906 is coupled to the control signal line 911.

The difference between the charge pump pixel driving circuit 900 and the charge pump pixel driving circuit 300 of the first preferred embodiment as shown in FIG. 3 is the third transistor 905 is a P-channel transistor such that the third transistor 905, the first transistor 903 and the second transistor 904 can share a control signal line. The design of the charge pump pixel driving circuit thus can be simplified.

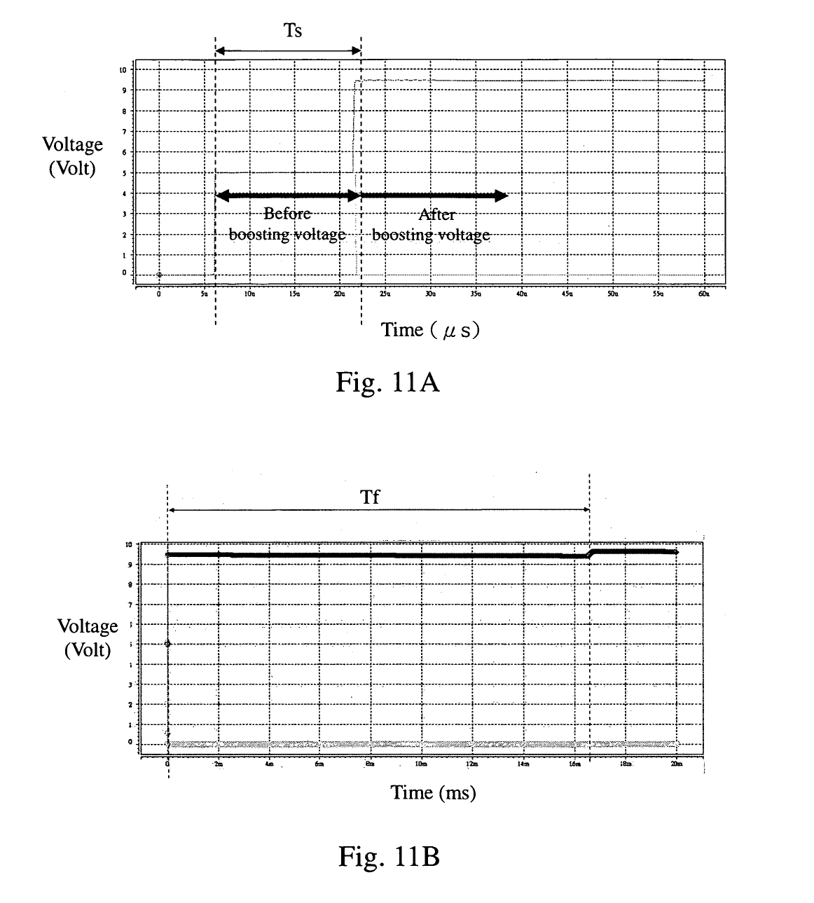

FIG. 10 is an operating waveform diagram of a control signal VSC1 sent from the control signal line 911 of the charge pump pixel driving circuit 900. A duration of t0˜t2 is a frame time Tf. From t0˜t1, the control signal VSC1 is a high voltage-level signal to switch on the first transistor 903, the second transistor 904 and the fourth transistor 906 such that the signal voltage VA of the data signal line 910 is coupled to the first ends of the first storage capacitor 901 and the second storage capacitor 902. As a result, the first ends of the first storage capacitor 901 and the second storage capacitor 902 are charged to a voltage equal to the signal voltage VA. At this time, the control-signal is a high voltage-level signal, and the third transistor 905 is switched off. From t1˜t2, the control signal is a low voltage-level signal to switch off the first transistor 903, the second transistor 904 and the fourth transistor 906 such that the signal voltage VA is decoupled from the first storage capacitor 901 and the second storage capacitor 902. At this time, the third transistor 905 is switched on such that the first end of the first storage capacitor 901 is coupled to the second end of the second storage capacitor 902. As a result, the voltage VB of the first end of the second storage capacitor 902 is boosted to approximately twice the signal voltage (2VA), and thus providing the voltage approximately twice the signal voltage to the first pixel electrode 908 of the pixel 907.

FIG. 11A is a voltage diagram of the output voltage VB of the charge pump pixel driving circuit 900 during a unit scan time Ts of the control signal line 911. From this diagram, it is found that the voltage VA (about 5 volts) stored in the first storage capacitor 901 through switching on the third transistor 905 makes the output voltage VB boost to twice the signal voltage (2VA about 10 volts). FIG. 11B is a voltage diagram of the output voltage VB during a frame time (Tf about 16.7 ms). From this diagram, it is found that the output voltage VB is barely decayed after passing through a frame time Tf. As such, the charge pump pixel driving circuit also has charge holding capability, that is, the signal voltage is firstly stored in the first storage capacitor 901 such that the output voltage VB is not influenced by the fluctuation of the signal voltage transmitted on the data signal line 910. The performance of display color is maintained.

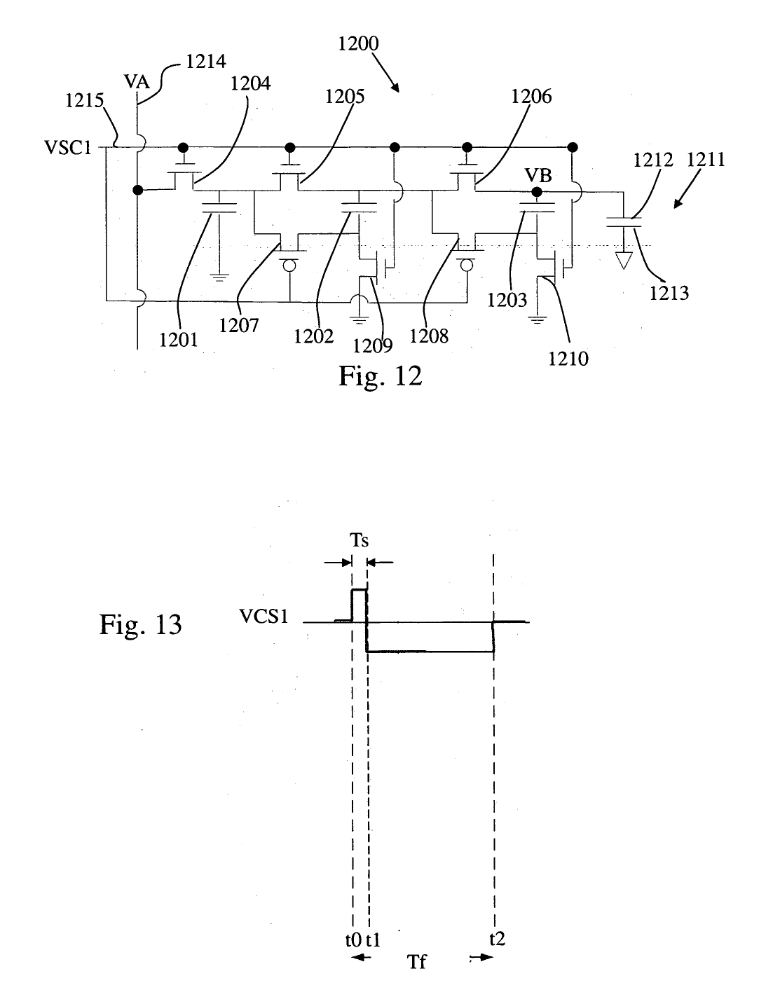

FIG. 12 is a schematic view of the charge pump pixel driving circuit in accordance with a fourth preferred embodiment of the present invention. In the fourth preferred embodiment, the charge pump pixel driving circuit 1200 includes a first storage capacitor 1201, a second storage capacitor 1202, a third storage capacitor 1203 and a switch means having a first transistor 1204, a second transistor 1205, a third transistor 1206, a fourth transistor 1207, a fifth transistor 1208, a sixth transistor 1209 and a seventh transistor 1210 in which the first transistor 1204, the second transistor 1205, the third transistor 1206, the sixth transistor 1209 and the seventh transistor 1210 are N-channel transistors, while the fourth transistor 1207 and the fifth transistor 1208 are P-channel transistors. A first end of the first storage capacitor 1201 is coupled to a source of the first transistor 1204, a drain of the second transistor 1205 and a drain of the fourth transistor 1207, while a second end of the first storage capacitor 1201 is grounded. A first end of the second storage capacitor 1202 is coupled to a source of the second transistor 1205, a drain of the third transistor 1206 and a drain of the fifth transistor 1208, while a second end of the second storage capacitor 1202 is coupled to a source of the fourth transistor 1207 and a source of the sixth transistor 1209. A first end of the third storage capacitor 1203 is coupled to a source of the third transistor 1206 and a first pixel electrode 1212 of a pixel 1211, while a second pixel electrode 1213 of the pixel 1211 is coupled to a common reference voltage (Vcom). A second end of the third storage capacitor 1203 is coupled to a source of the fifth transistor 1208 and a source of the seventh transistor 1210. The drain of the first transistor 1204 is coupled to a data signal line 1214, and the source of the first transistor 1204 is coupled to the first end of the first storage capacitor 1201, the drain of the second transistor 1205 and the drain of the fourth transistor 1207, as well as a gate of the first transistor 1204 is coupled to a control signal line 1215. The drain of the second transistor 1205 is coupled to the first end of the first storage capacitor 1201, the source of the first transistor 1204 and the drain of the fourth transistor 1207. The source of the second transistor 1205 is coupled to the first end of the second storage capacitor 1202, the drain of the third transistor 1206 and the drain of the fifth transistor 1208, and a gate of the second transistor 1205 is coupled to the control signal line 1215. The drain of the third transistor 1206 is coupled to a first end of the second storage capacitor 1202, a source of the second transistor 1205 and the drain of the fifth transistor 1208. The source of the third transistor 1206 is coupled to the first end of the third storage capacitor 1203, while a gate of the third transistor 1206 is coupled to the control signal line 1215. The drain of the fourth transistor 1207 is coupled to the first end of the first storage capacitor 1201, the source of the first transistor 1204 and the drain of the second transistor 1205. The source of the fourth transistor 1207 is coupled to the second end of the second storage capacitor 1202 and the source of the sixth transistor 1209, and a gate of the fourth transistor 1207 is coupled to the control signal line 1215. The drain of the fifth transistor 1208 is coupled to the first end of the second storage capacitor 1202, the source of the second transistor 1205 and the drain of the third transistor 1206. The source of the fifth transistor 1208 is coupled to the second end of the third storage capacitor 1203 and the source of the seventh transistor 1210, while a gate of the fifth transistor 1208 is coupled to the control signal line 1215. The source of the sixth transistor 1209 is coupled to the second end of the second storage capacitor 1202 and the source of the fourth transistor 1207. The drain of the sixth transistor 1209 is grounded, and a gate of the sixth transistor 1209 is coupled to the control signal line 1215. The source of the seventh transistor 1210 is coupled to the second end of the third storage capacitor 1203 and the source of the fifth transistor 1208. The drain of the seventh transistor 1210 is grounded, and a gate of the seventh transistor 1210 is coupled to the control signal line 1215.

The difference between the charge pump pixel driving circuit 1200 and the charge pump pixel driving circuit 600 of the second preferred embodiment as shown in FIG. 6 is the fourth transistor 1207 and fifth transistor 1208 are P-channel transistors such that the fourth transistor 1207, the fifth transistor 1208, the first transistor 1204, the second transistor 1205, the third transistor 1206, the sixth transistor 1209 and the seventh transistor 1210 can share a control signal line. As such, the design of the pixel driving circuit can be simplified.

FIG. 13 is an operating waveform diagram of a control signal VSC1 sent from the control signal line 1215 of the charge pump pixel driving circuit 1200. A duration of t0˜t2 is a frame time Tf. From t0˜t1, the control signal is a high voltage-level signal to switch on the first transistor 1204, the second transistor 1205, the third transistor 1206, the sixth transistor 1209 and the seventh transistor 1210 such that the signal voltage VA of the data signal line 1214 is coupled to the first ends of the first storage capacitor 1201, the second storage capacitor 1202 and the third storage capacitor 1203. As a result, the first ends of the first storage capacitor 1201, the second storage capacitor 1202 and the third storage capacitor 1203 are charged to a voltage equal to the signal voltage VA. At this time, the control signal is a high voltage-level signal, and the fourth transistor 1207 and the fifth transistor 1208 are switched off. From t1˜t2, the control signal VSC1 is low voltage-level signal to switch off the first transistor 1204, the second transistor 1205, the third transistor 1206, the sixth transistor 1209 and the seventh transistor 1210 such that the signal voltage VA of the data signal line 1214 is decoupled from the first ends of the first storage capacitor 1201, the second storage capacitor 1202 and the third storage capacitor 1203. At this time, the fourth transistor 1207 and the fifth transistor 1208 are switched on such that the first end of the first storage capacitor 1201 is coupled to the second end of the second storage capacitor 1202, and hence the first end of the second storage capacitor 1202 is boosted to approximately twice the signal voltage (2VA). At the same time, the first end of the second storage capacitor 1202 is coupled to the second end of the third storage capacitor 1203, and thus the voltage VB of the first end of the third storage capacitor 1203 is boosted to approximately three times the signal voltage (3VA), and thus providing the voltage approximately three times the signal voltage to the first pixel electrode 1212 of the pixel 1211.

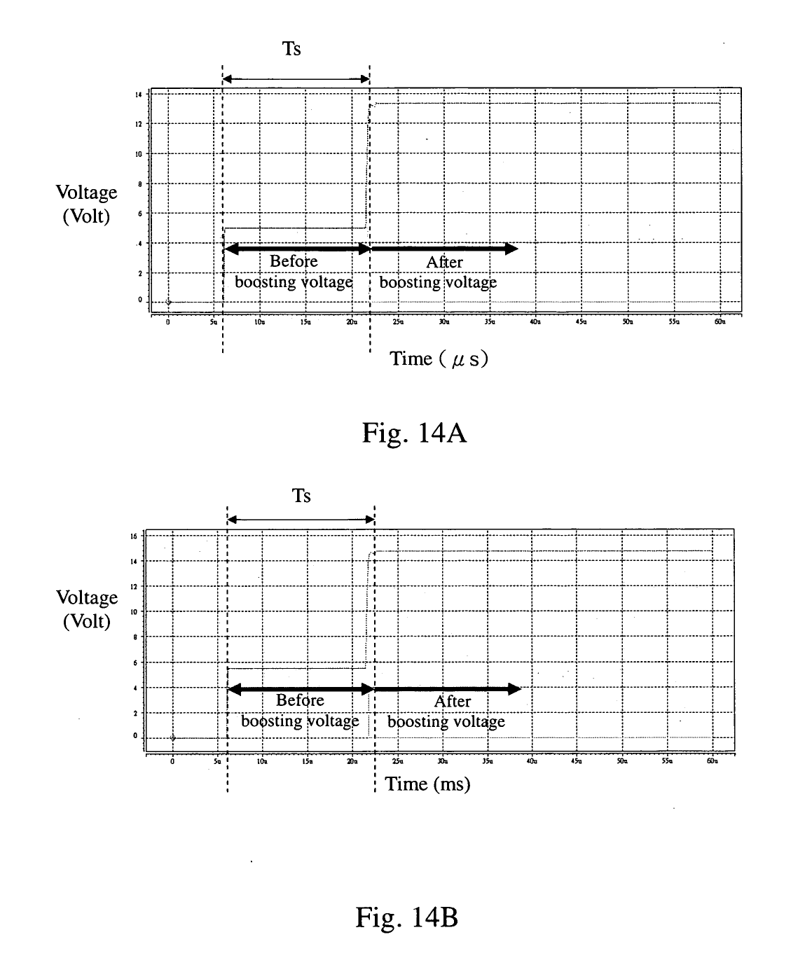

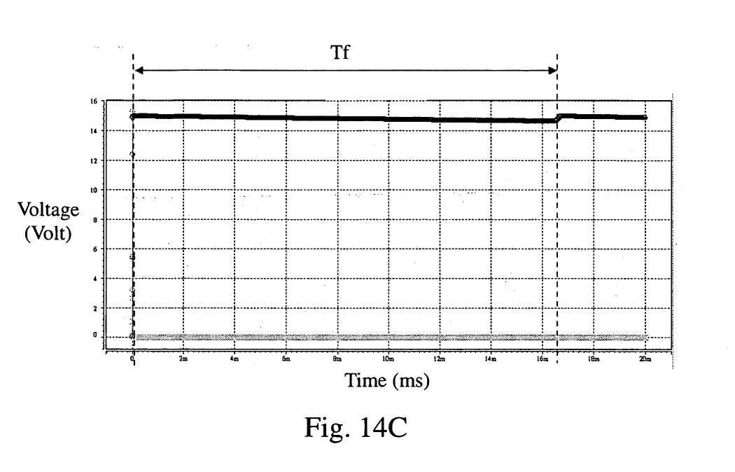

FIG. 14A is a voltage diagram of the output voltage VB of the charge pump pixel driving circuit 1200 during a unit scan time Ts of the control signal line 1215. From this diagram, it is found that the voltage VA (about 5 volts) stored in the first storage capacitor 1201 and the second storage capacitor 1202 through switching on the fourth transistor 1207 and the fifth transistor 1208 make the output voltage VB boost but fail to approximate to three times the signal voltage (15 volts). This is because the control signal line 1215 needs to provide negative voltage signal (low voltage-level signal) to switch on the fourth transistor 1207 and the fifth transistor 1208, and the voltages are thus pulled down. This phenomenon can be alleviated by changing the inputted signal voltage VA to 5.5 volts so as to boost the output voltage VB to approximately three times the signal voltage (3VA about 15 volts). FIG. 14B is a voltage diagram of the output voltage VB during a unit scan time Ts of the control signal line 1215 after the signal voltage is changed to 5.5 volts. From this diagram, it is found that the output voltage VB is boosted to approximately three times the signal voltage (15 volts). FIG. 14C is a voltage diagram of the output voltage VB of FIG. 14B during a frame time (Tf about 16.7 ms). From this diagram, it is found that the output voltage VB is barely decayed after passing through a frame time Tf. As such, the charge pump pixel driving circuit 1200 also has charge holding capability, that is, the signal voltage VA is firstly stored in the first storage capacitor 1201 such that the output voltage VB is not influenced by the fluctuation of the signal voltage transmitted on the data signal line 1214. The performance of color display is maintained.

The charge pump pixel driving circuit of the present invention can provide twice or more times pixel driving voltage. In the circuit design, the present invention firstly stores the data signal voltage in a storage capacitor such that the output voltage of the pixel driving circuit can keep constant and is not influenced by the fluctuation of the signal voltage transmitted on the data line so as to advantageously maintain the color display. The charge pump pixel driving circuit of the present invention is suitable for colorful display panels and can meet the demand of the current display devices. In addition, the charge pump pixel driving circuit of the present invention also can use only one control signal line to simplify the pixel driving circuit design.

While the invention will be described by way of examples and in terms of preferred embodiments, it is to be understood that those who are familiar with the subject art can carry out various modifications and similar arrangements and procedures described in the present invention and also achieve the effectiveness of the present invention. Hence, it is to be understood that the description of the present invention should be accorded with the broadest interpretation to those who are familiar with the subject art, and the invention is not limited thereto.

What is claimed is:

1. A charge pump pixel driving circuit for providing a voltage to a pixel electrode, comprising:
a first storage capacitor having a first end and a second end, wherein said second end is grounded;
a second storage capacitor having a first end and a second end, wherein said first end is coupled to said pixel electrode;
a switch means responsive to a first control signal to couple a signal voltage to said first ends of said first storage capacitor and said second storage capacitor until said first ends of said first storage capacitor and said second storage capacitor are charged to a voltage equal to the signal voltage, and then decoupling the signal voltage from said first ends of said first storage capacitor and said second storage capacitor and making said first end of said first storage capacitor couple to said second end of said second storage capacitor such that said first end of said second storage capacitor provides approximately twice the signal voltage to said pixel electrode.

2. The charge pump pixel driving circuit of claim 1, wherein said switch means comprises:
a first transistor having a drain coupled to the signal voltage, a source coupled to said first end of said storage capacitor and a gate coupled to said first control signal for switching on/or switching off said first transistor such that the signal voltage is coupled to or decoupled from said first end of said first storage capacitor; and
a second transistor having a drain coupled to said first end of said first storage capacitor, a source coupled to said first end of said second storage capacitor and a gate coupled to said first control signal for switching on/or switching off said second transistor such that the signal voltage is coupled to or decoupled from said first end of said second storage capacitor.

3. The charge pump pixel driving circuit of claim 2, wherein said switch means further comprises:
a third transistor having a drain coupled to said first end of said first storage capacitor, a source coupled to said second end of said second storage capacitor and a gate coupled to a second control signal for switching on/or switching off said third transistor such that said first end of said first storage capacitor is coupled to or decoupled from said second end of said second storage capacitor.

4. The charge pump pixel driving circuit of claim 3, wherein said switch means further comprises:
a fourth transistor having a drain coupled to said second end of said second storage capacitor, a source grounded and a gate coupled to said first control signal such that when the signal voltage is coupled to said first end of said first storage capacitor and said first end of said second storage capacitor, said fourth transistor is switched on, while when the signal voltage is decoupled from said first end of said first storage capacitor and said first end of said second storage capacitor, said fourth transistor is switched off.

5. The charge pump pixel driving circuit of claim 2, wherein said switch means further comprises:
a third transistor having a drain coupled to said first end of said first storage capacitor, a source coupled to said second end of said second storage capacitor and a gate coupled to said first control signal such that when the signal voltage is coupled to said first end of said storage capacitor, said third transistor is switched off, while when the signal voltage is decoupled from said first end of said first storage capacitor, said third transistor is switched on.

6. The charge pump pixel driving circuit of claim 5, wherein said switch means further comprises:
a fourth transistor having a drain coupled to said second end of said second storage capacitor, a source grounded and a gate coupled to said first control signal such that when the signal voltage is coupled to said first end of said first storage capacitor and said first end of said second storage capacitor, said fourth transistor is switched on, while when the signal voltage is decoupled from said first end of said first storage capacitor and said first end of said second storage capacitor, said fourth transistor is switched off.

7. A charge pump pixel driving circuit for providing a voltage to a pixel electrode, comprising:
a first storage capacitor having a first end and a second end, wherein said second end is grounded;
a second storage capacitor having a first end and a second end, wherein said first end is coupled to said first end of said first storage capacitor;
a third storage capacitor having a first end and a second end, wherein said first end is coupled to said first end of said second storage capacitor and said pixel electrode; and
a switch means responsive to a first control signal to couple a signal voltage to said first ends of said first storage capacitor, said second storage capacitor and said third storage capacitor until said first ends of said first storage capacitor, said second storage capacitor and said third storage capacitor are charged to a voltage equal to the signal voltage, and making the signal voltage decoupled from said first ends of said first storage capacitor, said second storage capacitor and said third storage capacitor, and making said first end of said first storage capacitor coupled to said second end of said second storage capacitor and said first end of said second storage capacitor coupled to said second end of said third storage capacitor such that said first end of said third storage capacitor provides approximately three times the signal voltage to said pixel electrode.

8. The charge pump pixel driving circuit of claim 7, wherein said switch means comprises:
a first transistor having a drain coupled to the signal voltage, a source coupled to said first end of said first storage capacitor and a gate coupled to said control signal for switching on/or switching off said first transistor such that the signal voltage is coupled to or decoupled from said first end of said first storage capacitor;
a second transistor having a drain coupled to said first end of said first storage capacitor, a source coupled to said first end of said second storage capacitor and a gate coupled to said first control signal for switching on/or switching off said second transistor such that the signal voltage is coupled to or decoupled from said first end of said second storage capacitor; and
a third transistor having a drain coupled to said first end of said second storage capacitor, a source coupled to said first end of said third storage capacitor and a gate coupled to said first control signal for switching on/or switching off said third transistor such that the signal voltage is coupled to or decoupled from said first end of said third storage capacitor.

9. The charge pump pixel driving circuit of claim 8, wherein said switch means comprises:
a fourth transistor having a drain coupled to said first end of said first storage capacitor, a source coupled to said second end of said second storage capacitor and a gate coupled to a second control signal for switching on/or switching off said fourth transistor such that said first end of said first storage capacitor is coupled to said second end of said second storage capacitor; and
a fifth transistor having a drain coupled to said first end of said second storage capacitor, a source coupled to said second end of said third storage capacitor and a gate coupled to said second control signal for switching on/or switching off said fifth transistor such that said first end of said second storage capacitor is coupled to or decoupled from said second end of said third storage capacitor.

10. The charge pump pixel driving circuit of claim 9, wherein said switch means comprises:
a sixth transistor having a drain coupled to said second end of said storage capacitor, a source grounded and a gate coupled to said first control signal such that when the signal voltage is coupled to said first end of said first storage capacitor and said first end of said second storage capacitor, said sixth transistor is switched on, while when the signal voltage is decoupled from said first end of said first storage capacitor and said first end of said second storage capacitor, said sixth transistor is switched off; and
a seventh transistor having a drain coupled to said second end of said third storage capacitor, a source grounded and a gate coupled to said first control signal such that when the signal voltage is coupled to said first end of said first storage capacitor, said first end of said second storage capacitor and said first end of said third storage capacitor, said seventh transistor is switched on, while when the signal voltage is decoupled from said first end of said first storage capacitor, said first end of said second storage capacitor and said first end of said third storage capacitor, said seventh transistor is switched off.

11. The charge pump pixel driving circuit of claim 8, wherein said switch means comprises:
a fourth transistor having a drain coupled to said first end of said first storage capacitor, a source coupled to said second end of said second storage capacitor and a gate coupled to said first control signal such that when the signal voltage is coupled to said first end of said first storage capacitor, said first end of said second storage capacitor and said first end of said third storage capacitor, said fourth transistor is switched off, while when the signal voltage is decoupled from said first end of said first storage capacitor, said first end of said second storage capacitor and said first end of said third storage capacitor, said fourth transistor is switched on; and
a fifth transistor having a drain coupled to said first end of said second storage capacitor, a source coupled to said second end of said third storage capacitor and a gate coupled to said first control signal such that when the signal voltage is coupled to said first end of said first storage capacitor, said first end of said second storage capacitor and said first end of said third storage capacitor, said fifth transistor is switched off, while when the signal voltage is decoupled from said first end of said first storage capacitor, said first end of said second storage capacitor and said first end of said third storage capacitor, said fifth transistor is switched on.

12. The charge pump pixel driving circuit of claim 11, wherein said switch means comprises:
a sixth transistor having a drain coupled to said second end of said second storage capacitor, a source grounded and a gate coupled to said first control signal such that when the signal voltage is coupled to said first end of said first storage capacitor and said first end of said second storage capacitor, said sixth transistor is switched on, while when the signal voltage is decoupled from said first end of said first storage capacitor and sad first end of said second storage capacitor, said sixth transistor is switched off; and
a seventh transistor having a drain coupled to said second end of said third storage capacitor, a source grounded and a gate coupled to said first control signal such that when the signal voltage is coupled to said first end of said first storage capacitor, said first end of said second storage capacitor and said first end of said third storage capacitor, said seventh transistor is switched on, while when the signal voltage is decoupled from said first end of said first storage capacitor, said first end of said second storage capacitor and said first end of said third storage capacitor, said seventh transistor is switched off.
